(19) United States
(12) Patent Application Publication
(10) Pub. No.: US 2008/0024811 A1
(43) Pub. Date: Jan. 31, 2008

(54) SHEET PROCESSING SYSTEM

(75) Inventors: TOMOKAZU NAKAMURA, Chiba (JP); Akihiro Sato, Kanagawa (JP); Akihiro Shimizu, Chiba (JP); Tatsuya Goto, Chiba (JP); Katsuaki Hirai, Ibaraki (JP); Hideki Kushida, Ibaraki (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/866,033

(22) Filed: Oct. 2, 2007

Related U.S. Application Data
(63) Continuation of application No. 10/963,651, filed on Oct. 14, 2004.

(30) Foreign Application Priority Data
Oct. 16, 2003 (JP) 2003-356736

(51) Int. Cl. G06F 3/12

(52) U.S. Cl. 358/1.13

(57) ABSTRACT

To provide a sheet processing system having a high productivity that can execute plural jobs in parallel, one job of loading a sheet on which an image is formed in the printer to the sheet stacking device and another job served as bookbinding job of bundling and binding a plurality of special sheets stored in the inserter in the finisher to output are executed in parallel.

### BACKGROUND OF THE INVENTION

1. Field of the Invention

This invention relates to a sheet processing system, in particular, a sheet processing system in which a plurality of sheet processing apparatuses having various functions such as image forming function of forming an image on a sheet, inserting function of outputting a sheet on which an image is not formed and staple function of aligning and bundling sheets are combined arbitrarily to perform a plurality of jobs such as bookbinding and piling of sheets on which an image is formed in parallel.

2. Description of the Related Art

Conventional sheet processing systems can perform serial processing ranging from print process as image forming process to bookbinding process including special sheet insertion, folding and binding by connecting a buffer device for temporally placing sheets, an inserter for outputting sheets on which an image is not formed, a finisher for aligning and bundling a lot of sheets, etc. to a sheet output device such as copying machine for outputting sheets in series.

FIG. 16 shows the conventional sheet processing system of this type.

In JP-A-2003-89473, there is disclosed an image forming system, in which a plurality of sheet after-treatment devices are connected to an image forming device. FIG. 16 is a schematic sectional view showing one example of the image forming system of the related art schematically. An image forming system B, as shown in FIG. 32, is provided with a document feeder 1100, an image forming device 1000 having an image reader 1200 and a printer 1300, a buffer module 1400, a folder 1500 and a finisher 1600.

In this image forming system B, however, the folder 1500 or the finisher 1600 cannot be used while the sheets are being conveyed for a job from the printer 1300 to the buffer module 1400. The execution of another job has to await the end of the aforementioned job. This lowers the working efficiency of the entire system seriously.

### SUMMARY OF THE INVENTION

An object of the present invention is to solve the above-mentioned problem of the conventional sheet processing system, and to provide a sheet processing system in which one preceding job and another job can be executed in parallel before terminating the former job, thereby to improve productivity.

To achieve the above-mentioned object, the sheet processing system of the present invention comprises a plurality of sheet processing apparatuses each having a sheet processing function; and a controller which executes a job of sheet processing using a sheet processing apparatus and/or a job of sheet processing using a combination of plural sheet processing apparatuses, the controller capable of executing plural jobs in parallel,

wherein, when the sheet processing apparatus or the combination of plural sheet processing apparatuses are selected in order to execute plural jobs, the sheet processing apparatus which executes one job, or at least one sheet processing apparatus in the upstream in the direction of conveying the sheet among the selected combination of the sheet processing apparatuses which executes one job differs from the sheet processing apparatus which executes other job, or at least one sheet processing apparatus in the upstream in the direction of conveying the sheet among the selected combination of the sheet processing apparatuses which executes other job.

According to a preferred aspect of this invention, the controller executes one of the plural jobs in a combination of sheet processing apparatuses adjacent to each other.

According to another preferred aspect of this invention, one of the plural jobs is executed in a combination of sheet processing apparatuses adjacent to each other, while another job is executed in a combination of sheet processing apparatuses adjacent to each other except for the sheet processing apparatuses that execute one job.

According to still another preferred aspect of this invention, the plurality of sheet processing apparatuses are sheet output device for outputting the sheet or post-processing devices for applying post-processing to the sheet output from the sheet output device.

According to still another preferred aspect of this invention, the sheet output devices are an image forming apparatus that forms an image on a sheet and output the sheet, an inserter that does not form an image on a sheet and output the sheet, a buffer device that temporarily holds the sheet output from other sheet output device and reoutput the sheet or a sheet feeding device for feeding the sheet to other sheet processing apparatus.

According to still another preferred aspect of this invention, the sheet post-processing devices are a punching device for punching sheets, a binding device for binding sheets, a storing device for storing sheets, an aligning device for aligning sheets, a folding device for folding sheets or bookbinding device for binding sheets.

According to still another preferred aspect of this invention, the plurality of sheet processing apparatuses are arranged in series and a sheet conveyance means for conveying the sheet between the sheet conveyance devices adjacent to each other is provided, and the sheet conveyance means is connected from the most upstream sheet processing apparatus to the most downstream sheet processing apparatus in the direction of outputting the sheet.

According to still another preferred aspect of this invention, the sheet conveyance means has a first sheet conveyance means used in executing one of the plural jobs, and a second sheet conveyance means used in executing the other job.

According to still another preferred aspect of this invention, blocking means for blocking passage of the sheet is provided between the first sheet conveyance means and the second sheet conveyance means.

According to still another preferred aspect of this invention, a partition for separating the sheet processing apparatus that executes one of the plural jobs in parallel from the sheet processing apparatus that executes the other job is provided.

According to still another preferred aspect of this invention, cover members that allow the interior of the sheet processing apparatuses to become opened are provided so that the sheet processing apparatus that executes one of the plural jobs executed in parallel and the sheet processing apparatus that executes the other job can be maintained separately.

As mentioned above, according to the present invention, it is provide the sheet processing system having a high productivity that can execute plural jobs in parallel.

### BRIEF DESCRIPTION OF THE DRAWINGS

FIG. 1 is a schematic configuration view showing internal configuration of a sheet processing system in accordance with a first embodiment;

FIG. 2 is a schematic configuration view showing internal configuration of the sheet processing system in accordance with the first embodiment;

FIG. 3 is a schematic configuration view showing the sheet processing system in accordance with the first embodiment;

FIG. 4 is a schematic configuration view showing configuration of covering members according to the present invention;

FIG. 5 is a block diagram showing overall configuration of a controller for controlling the sheet processing system;

FIG. 6 is a block diagram showing configuration of a sheet stacking device control portion for driving and controlling a sheet stacking device;

FIG. 7 is a block diagram showing configuration of an inserter control portion for driving and controlling an inserter;

FIG. 8 is a block diagram showing configuration of a finisher control portion for driving and controlling a finisher;

FIG. 9 is a view illustrating operation of the sheet processing system;

FIG. 10 is a view illustrating operation of the sheet processing system;

FIG. 11 is a view illustrating open-close operation of a cover of the sheet processing system;

FIG. 12 is a view illustrating configuration of partitions;

FIG. 13 is a schematic configuration view showing internal configuration of a sheet processing system in accordance with a second embodiment;

FIG. 14 is a schematic configuration view showing internal configuration of a sheet processing system in accordance with a third embodiment;

FIG. 15 is a schematic configuration view showing internal configuration of a sheet processing system in accordance with a fourth embodiment; and

FIG. 16 is a schematic configuration view showing configuration of a conventional sheet processing system.

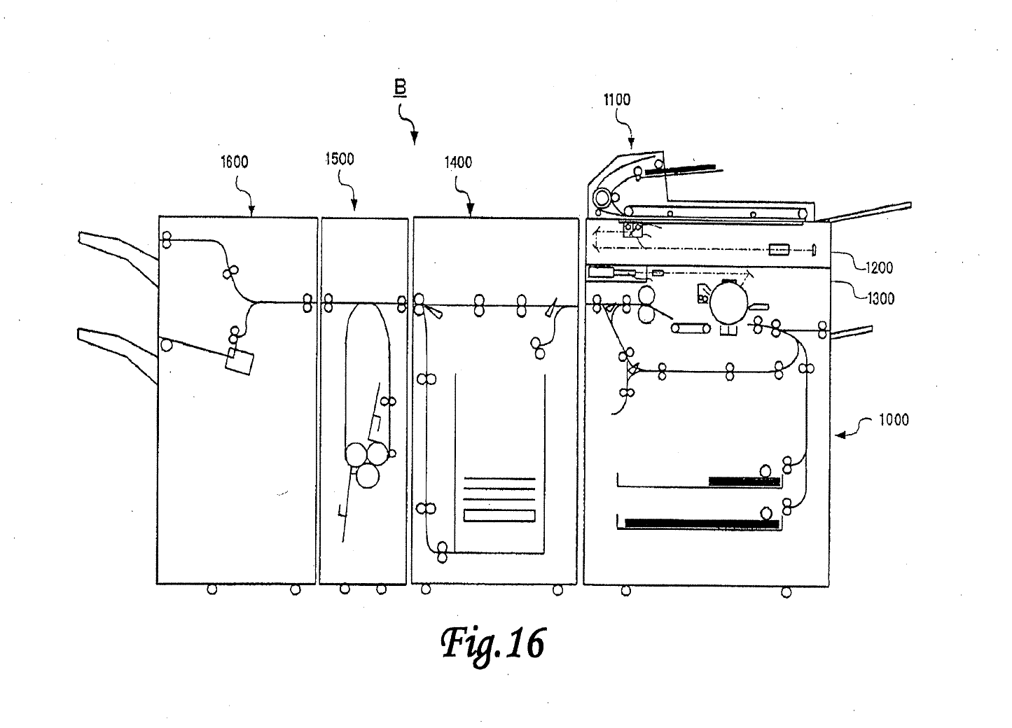

### DESCRIPTION OF THE PREFERRED EMBODIMENTS

While preferred embodiments of the present invention will be described in detail below referring to the appended figures. It is to be understood that this invention be not limited by the description of the size, material, shape and other relative arrangement of parts in the embodiments, unless otherwise specified.

### First Embodiment

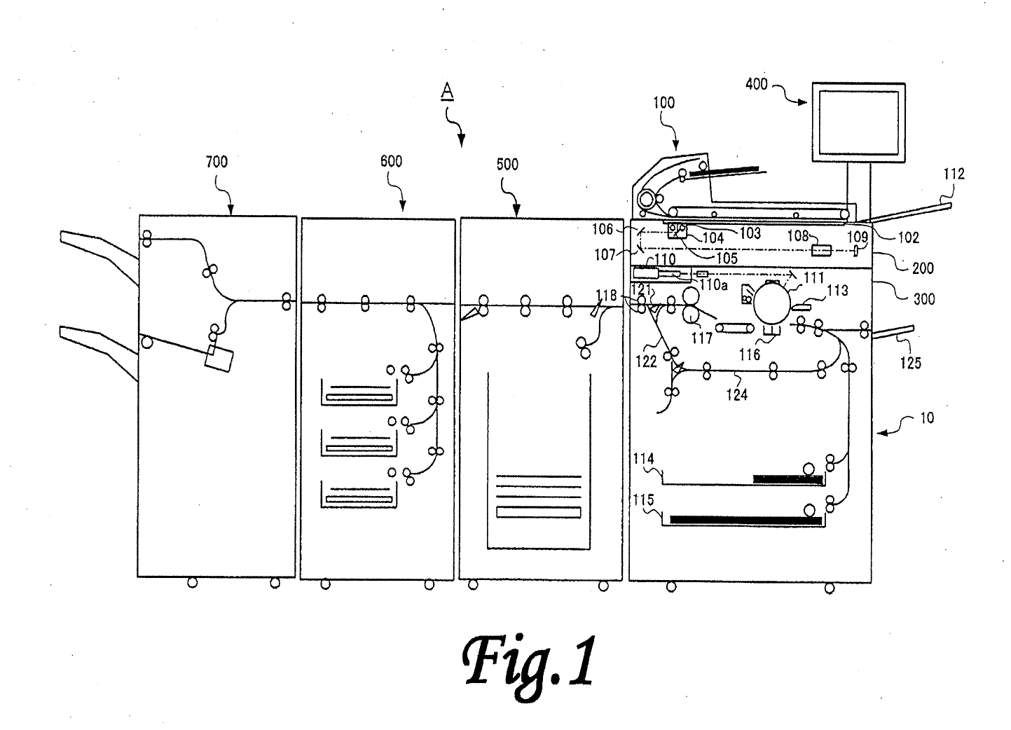

FIG. 1 is a schematic configuration view showing internal configuration of a sheet processing system in accordance with a first embodiment.

The sheet processing system A of this embodiment is configured so that an image forming apparatus 10 (printer 300), each of which has a sheet processing function of its own, a sheet stacking device 500, an inserter 600 and a finisher 700 are serially connected in this order.

[Image Forming Apparatus 10]

The image forming apparatus 10 serves to read a document and form image on a sheet and has a printer 300, an image reader 200 that is mounted on the printer 300 and reads an image of the document, a document feeding device 100 mounted on the image reader 200 so as to be opened or closed freely and an operation display device 400 disposed above the image reader 200.

The document feeding device 100 picks the plurality of documents set on a document tray upwards one by one from the first page, conveys the document to the document image reading position of the image reader 200 through a curved path and makes the image reader 200 skim through the document. Subsequently, the document is delivered to a sheet exit tray 112 placed at the right end of the document feeding device 100.

The image reader 200 serves to read the document, and has a platen glass 102 on its upper face and scanner unit 104 under the platen glass 102 that reads an image of the document fed from the document feeding device 100 to the document image reading position on the platen glass 102.

Here, the document is skimmed through by applying light of a lamp 103 provided in the scanner unit 104 to the surface to be read of the document when the document passes over the document image reading position on the platen glass 102, guiding the reflected light from the document into an image sensor 109 by a mirror 105 provided in the scanner unit 104 and mirrors 106 and 107 provided in the image reader 200, sequentially, and converting the light into an electric signal by the image sensor 109 to be read. Accordingly, by conveying the document from left to light in the figure through the document image reading position on the platen glass 102, the document image is read by one line by the image sensor 109 in a main scanning direction orthogonal to the document conveying direction, while the document image is also read by the image sensor 109 in a sub-scanning direction as the document conveying direction, thereby to read the entire document image.

Image data output from the image sensor 109 is input to the printer 300 as a video signal after being subjected to a predetermined image processing.

The printer 300 serves to form an image on a sheet based on the document image data read by the image reader 200 and has an exposure control portion 110 that modulate laser light in response to the input video signal based on the image data output from the image sensor 109, a photosensitive drum 111 on which an electrostatic latent image is formed, a polygon mirror 110a that applies the laser light output from the exposure control portion 110 to the photosensitive drum 111 while scanning, cassettes 114 and 115 that feed a sheet to a conveyance portion 116 disposed below the photosensitive drum 111, a manual sheet feeding portion 125, both sides conveying path 124, a fixing portion 117 that fixes the sheet to which the image of a developer formed on the photosensitive drum 111 is transferred in the conveyance portion 116 and a pair of discharge rollers 118 that discharge the sheet passing through the fixing portion 117 to the outside of the printer 300.

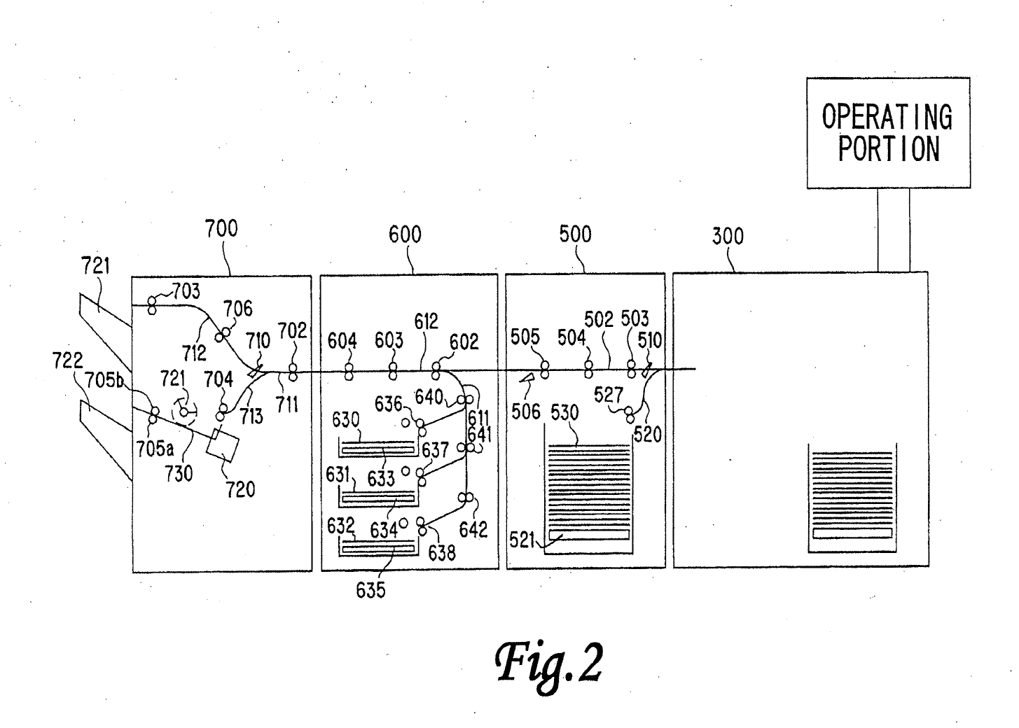

FIG. 2 is a schematic configuration view showing internal configuration of the sheet stacking device 500, the inserter 600 and the finisher 700 of the sheet processing system in accordance with the first embodiment.

[Sheet Stacking Device 500]

The sheet stacking device 500 is a buffer device that temporarily holds the sheet output from other sheet output device such as the printer 300 therein to be reoutput, and as shown in FIG. 2, a conveying horizontal path 502 as a sheet conveying path that guides the sheet discharged from the printer 300 into the inserter 600 and the finisher 700, pairs of conveying rollers 503, 504 and 505 that are provided along the conveying horizontal path 502 and convey the sheet, a first flapper 510 and a second flapper 506 disposed at an inlet portion (at the side of the printer 300) and an outlet portion (at the side of finisher 700) of the conveying horizontal path 502, respectively, a sheet loading portion 530 capable of storing the sheet discharged from the printer 300 therein and a path 520 that guides the sheet discharged from the printer 300 into the sheet loading portion 530.

When the sheet stacking device 500 loads the sheet, the first flapper 510 is switched so as to prevent the sheet from passing through the conveying horizontal path 502 and guides the sheet discharged from the printer 300 to the path 520. The sheet guided along the path 520 is loaded in the sheet loading portion 530 one after another.

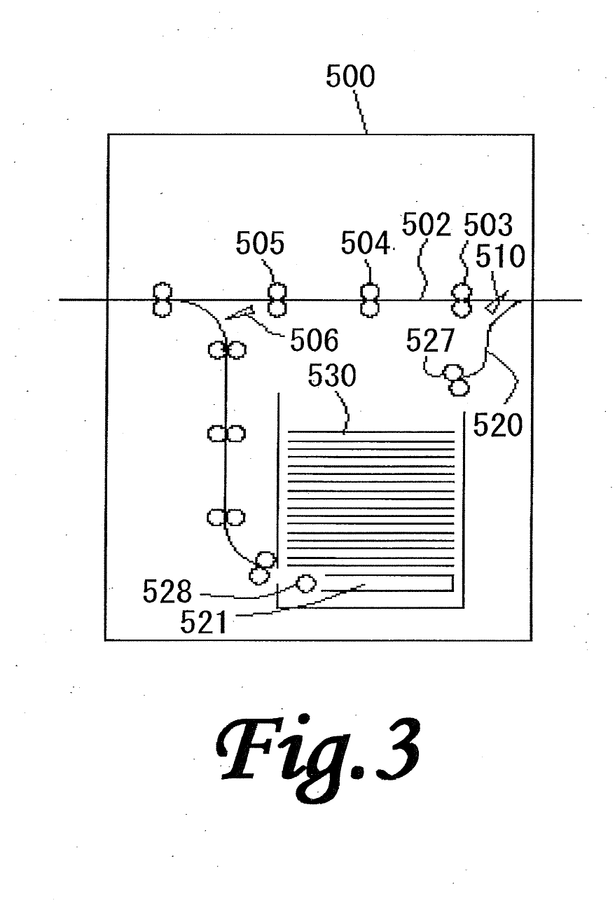

FIG. 3 shows the sheet stacking device. As shown in FIG. 3, the sheet stacking device 500 has a refeeding means 528 and the sheet loaded in the sheet stacking portion 530 is returned to the conveying horizontal path 502 again by the refeeding means 528 and conveyed to the inserter 600 and the finisher 700.

On the other hand, when sheet stacking device 500 does not load the sheet on the sheet stacking portion 530, the first flapper 510 is switched so as to prevent the sheet from passing through the path 520 and allows the sheet discharged from the printer 300 to be conveyed to the inserter 600 and the finisher 700 through the conveying horizontal path 502.

Alternatively, another path (not shown) for conveying the sheet loaded in the sheet stacking portion 530 temporarily to the inserter 600 and the finisher 700 may be provided. In this case, it becomes possible to regulate and control capacity of the printer 300, the inserter 600 and the finisher 700. The sheet stacking device 500 may also carry out only sheet stacking function without having buffer function.

[Finisher 700]

The finisher 700 serves to perform processing for sorting, binding, punching and so on, and as shown in FIG. 2, has a finisher path 711 and a pair of inlet rollers 702 for guiding the sheet output from the inserter 600, a non-sorting path 712 that conveys the sheet output from the inserter 600 to a sample tray 721 without sorting, a sorting path 713 that conveys the sheet output from the inserter 600 to the sort processing portion, a switch flapper 710 that switches between the non-sorting path 712 and the sorting path 713 selectively, an intermediate tray 730 that performs processing such as sorting and binding, a stapler 720 that performs processing such as binding of the sheet loaded and aligned on the intermediate tray 730 and a stack tray 722 to which the sheet subjected to processing such as sorting and binding on the intermediate tray 730 is discharged.

When the finisher 700 does not perform processing such as sorting, the switch flapper 710 is switched so as to prevent the sheet from passing through the sorting path 713 and the sheet output from the inserter 600 is guided by the non-sorting path 712 to be discharged onto the sample tray 721 via a pair of conveying rollers 706 and a pair of non-sorting discharge rollers 703 provided in the non-sorting path 712.

On the other hand, when the finisher 700 performs processing such as sorting, the switch flapper 710 is switched so as to prevent the sheet from passing through the non-sorting path 712 and the sheet output from the inserter 600 is guided by the sorting path 713 to be loaded on the intermediate tray 730 in a batch via a pair of sorting discharge rollers 704. Then, the sheet loaded on the intermediate tray 730 is subjected to processing such as aligning, stapling or punching appropriately and then discharged onto the stack tray 722 via a pair of discharge roller 705. The stack tray 722 is configured so as to be self-propelled in the vertical direction, if necessary.

[Inserter 600]

The inserter 600 serve to output the sheet on which an image is formed, for example, to feed special sheet printed separately (such as color copy sheet) or insert special sheet such as front cover and tab into the first or middle page of the sheets output from the printer 300. Further, as shown in FIG. 2, the inserter 600 has a conveying horizontal path 612 as a sheet conveying path that guides the sheet discharged from the pair of conveying rollers 505 provided in the sheet stacking device 500 into the finisher 700, pairs of conveying rollers 602, 603 and 604 disposed along the conveying horizontal path 612, sheet storing portions 630, 631 and 632 that store special sheet such as front cover and tab therein, sheet feeding separating portions 636, 637 and 638 that convey the special sheet stored in the sheet storing portions 630, 631 and 632, a conveying vertical path 611 that guides the special sheet fed from the sheet storing portions 630, 631 and 632 to the conveying horizontal path 612 and pairs of conveying rollers 640, 641 and 642 disposed along the conveying horizontal path 612.

This inserter 600 can store the special sheet printed separately for feeding and insert the special sheet such as front cover and tab between the sheets output from the printer 300 from the sheet storing portions 630, 631 and 632 at a predetermined timing at the user's request.

[Configuration of Exterior Cover]

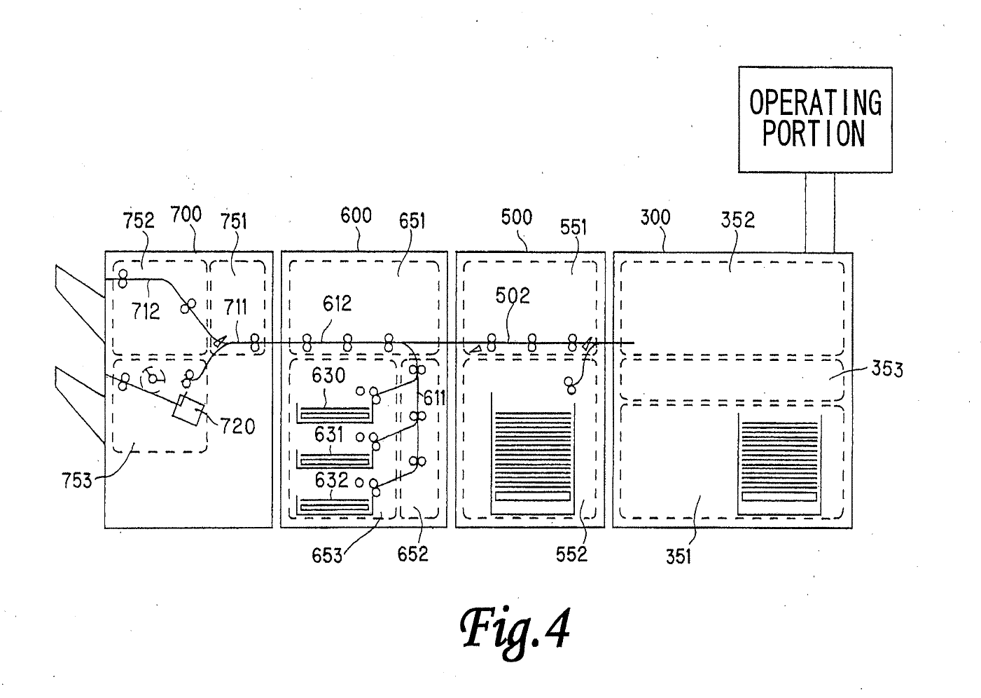

FIG. 4 is a schematic configuration view showing configuration of exterior covers of the printer 300, the sheet stacking device 500, the inserter 600 and the finisher 700.

The sheet processing system of this embodiment has covering members (hereinafter referred to as “cover”) that allow the interior of the printer 300, the sheet stacking device 500, the inserter 600 and the finisher 700, each of which is the sheet processing apparatus, to become opened.

In the sheet stacking device 500, a cover 551 for covering the conveying horizontal path 502 and a cover 552 for covering the sheet stacking portion 530 are provided. The cover 551 and the cover 552 each can be opened or closed independently. The open/close state of the cover 551 and the cover 552 is detected by cover open/close detecting sensors S54 and S55.

The cover 551 and the cover 552 are opened during operation for paper jam and maintenance including replacement of parts, cleaning, adjustment and ejection of sheet in the sheet stacking device 500.

In the inserter 600, a cover 651 for covering the conveying horizontal path 612, a cover 652 for covering the conveying vertical path 611, a cover 653 for covering the sheet storing portions 630, 631 and 632 and the sheet feeding separating portions 636, 637 and 638 are provided. The cover 651, the cover 652 and the cover 653 each can be opened or closed independently. The open/close state of the cover 651, the cover 652 and the cover 653 is detected by cover open/close detecting sensors S64, S65 and S66.

The cover 651, the cover 652 and the cover 653 are opened during operation for paper jam and maintenance including replacement of parts, cleaning, adjustment and resupply of sheet.

In the finisher 700, a cover 751 for covering the finisher path 711, a cover 752 for covering the non-sorting path 712 and a cover 753 for covering the stapler processing portion including the stapler 720 are provided. The cover 751, the cover 752 and the cover 753 each can be opened or closed independently. The open/close state of the cover 751, the cover 752 and the cover 753 is detected by cover open/close detecting sensors S74, S75 and S76.

The cover 751, the cover 752 and the cover 753 are opened during operation for paper jam and maintenance including replacement of parts, cleaning, adjustment and resupply of sheet.

In the printer 300, a cover 351 for covering the sheet supplying portion, a cover 352 for covering the photosensitive drum 111, the conveyance portion 116, the fixing portion 117, the flapper 121 and their respective conveying paths that guide the sheet and a cover 353 for covering the both sides conveying path 124 are provided. The cover 351, the cover 352 and the cover 353 each can be opened or closed independently. The open/close state of the cover 351, the cover 352 and the cover 353 is detected by cover open/close detecting sensors (not shown).

The cover 351, the cover 352 and the cover 353 are opened during operation for paper jam and maintenance including replacement of parts, cleaning, adjustment and resupply of sheet.

[Configuration of Controller]

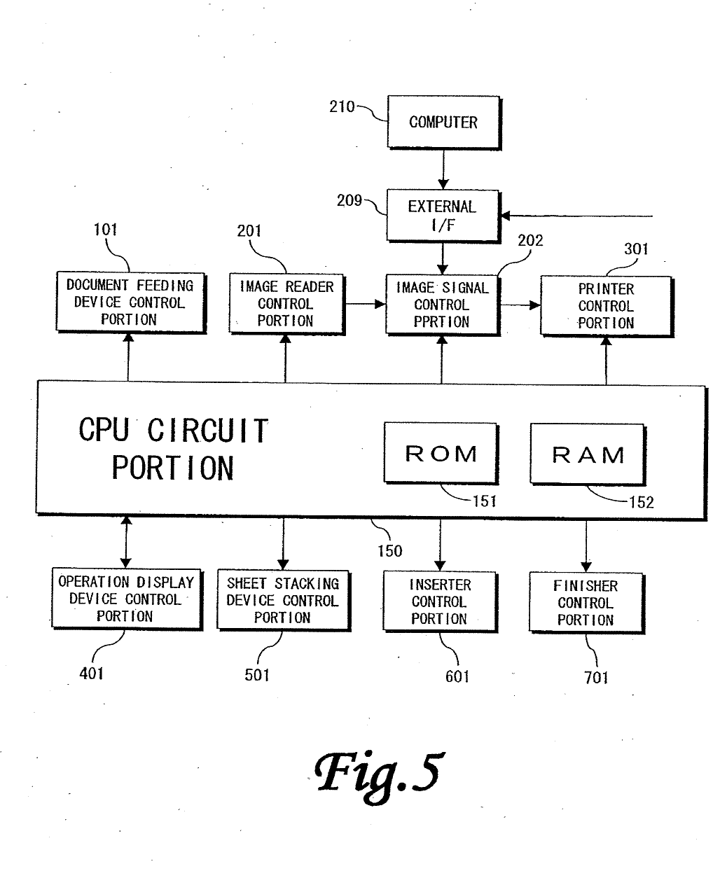

FIG. 5 is a block diagram showing overall configuration of a controller for controlling the sheet processing system in accordance with the first embodiment.

As shown in FIG. 5, the controller has a CPU circuit portion 150 and the CPU circuit portion 150 includes a CPU (not shown), a ROM 151 and a RAM 152 therein.

The CPU circuit portion 150 controls a document feeding device control portion 101, an image reader control portion 201, an image signal control portion 202, an external interface 209, a printer control portion 301, an operation display portion control portion 401, a sheet stacking device control portion 501, an inserter control portion 601 and a finisher control portion 701 in the block according to a control program stored in the ROM 151.

The RAM 152 built in the CPU circuit portion 150 temporarily holds control data for controlling each of the control portions and functions as an operational area of arithmetic processing associated with the control.

The document feeding device control portion 101 drives and controls the document feeding device 100 in response to an instruction from the CPU circuit portion 150.

The image reader control portion 201 drives and controls the scanner unit 104 and the image sensor 109 and conveys an analog image signal output from the image sensor 109 to the image signal control portion 202.

According to an instruction from the CPU circuit portion 150, the image signal control portion 202 converts the analog image signal applied from the image sensor 109 to a digital signal, applies some processing to the signal, converts the digital signal to a video signal and output the converted signal to the printer control portion 301. Moreover, the image signal control portion 202 applies various processing to a digital image signal input from a computer 210 through an external I/F 209, converts the digital image signal into a video signal and outputs the converted signal to the printer control portion 301. The printer control portion 301 drives the exposure control portion 110 according to the video signal input from the image signal control portion 202.

The operation display portion control portion 401 exchanges information between the operation display device 400 provided in the image forming apparatus 10 and the CPU circuit portion 150. The operation display device 400 has a plurality of keys for setting various functions about image formation and a display portion for displaying information indicating setting state of each sheet processing apparatus. A key signal corresponding to each of keys disposed at the operation display device 400 is output to the CPU circuit portion 150 through the operation display device control portion 401. The operation display device control portion 401 controls the operation display device 400 so that the display portion of the operation display device 400 displays corresponding information based on the signal sent from the CPU circuit portion 150.

The sheet stacking device control portion 501 is mounted in the sheet stacking device 500 and drives and controls the sheet stacking device 500 by exchanging information with the CPU circuit portion 150.

The inserter control portion 601 is mounted in the inserter 600 and drives and controls the inserter 600 by exchanging information with the CPU circuit portion 150.

The finisher control portion 701 is mounted in the finisher 700 and drives and controls the finisher 700 by exchanging information with the CPU circuit portion 150.

[Configuration of Sheet Stacking Device Control Portion]

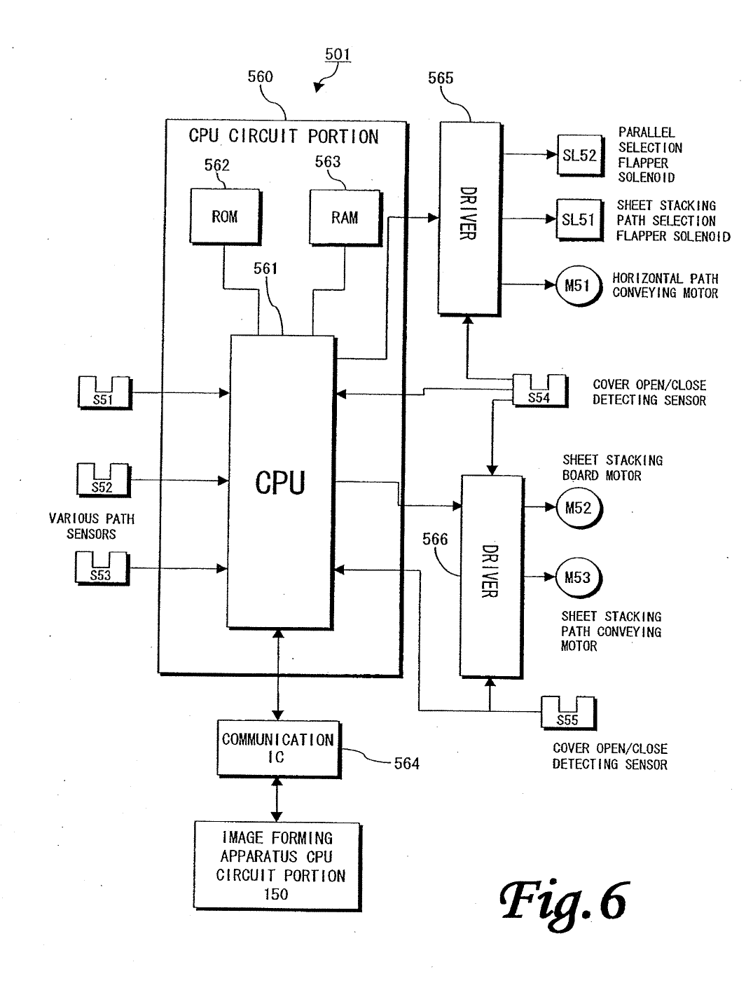

FIG. 6 is a block diagram showing configuration of the sheet stacking device control portion 501 for driving and controlling the sheet stacking device 500.

As shown in FIG. 6, the sheet stacking device control portion 501 has a CPU circuit portion 560 constituted by a CPU 561, a ROM 562 and a RAM 563. The CPU circuit portion 560 communicates and exchanges data with the CPU circuit portion 150 provided with the image forming apparatus 10 through a communication IC 564, and according to an instruction from the CPU circuit portion 150, executes various programs stored in the ROM 562 to drive and control the sheet stacking device 500. Further, the CPU circuit portion 560 receives input of detection signals from various path sensors S51, S52 and S53 for detecting delay or jam of sheet during conveying of sheets as well as detection signals from the cover open/close detecting sensors S54 and S55.

Drivers 565 and 566 are connected to the CPU circuit portion 560.

The driver 565 drives a motor M51, a solenoid SL51 and a solenoid SLS2 of a conveyance processing module according to the signal sent from the CPU circuit portion 560.

The driver 566 drives a motor M52 and a motor M53 of a sheet stacking processing module according to the signal sent from the CPU circuit portion 560.

Here, the conveyance processing module is constituted by the pairs of conveying rollers 503, 504 and 505 disposed in the sheet stacking device 500, the horizontal conveying motor M51 as a driving source for these rollers, the solenoid SL51 for switching the first flapper 510 and the solenoid SL52 for switching the second flapper 506.

The sheet stacking processing module is constituted by the sheet stacking board motor M52 as a driving source for a sheet stacking board 521 that constitutes the sheet stacking portion 530 and the sheet stacking conveying motor M53 as a driving source for the pair of conveying rollers 527 disposed at the path 520.

When it is detected that the cover 551 is in the opened state by the detection signal of the cover open/close detecting sensor S54, the power source of the driver 565 is shut off, thereby to forcefully stop driving of the conveyance processing module. At the same time, the power source of the driver 566 is also shut off, thereby to forcefully stop driving of the sheet stacking processing module.

On the other hand, when it is detected that the cover 552 is in the opened state by the detection signal of the cover open/close detecting sensor S55, only the power source of the driver 566 is shut off, thereby to forcefully stop driving of only the sheet stacking processing module.

[Configuration of Sheet Feeding Device Control Portion]

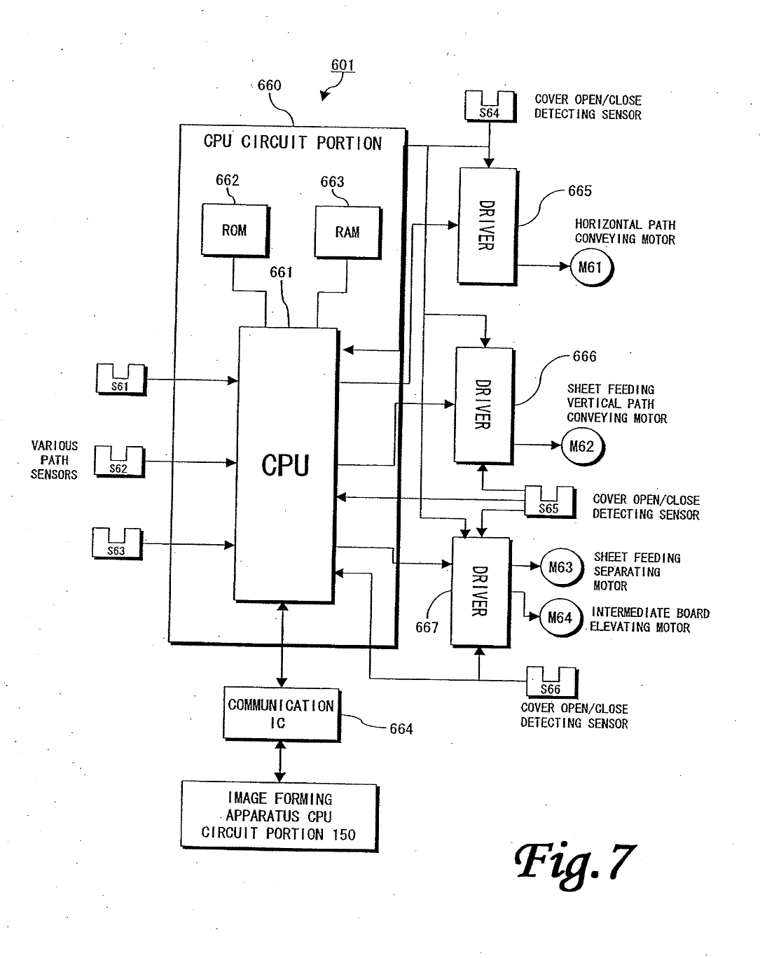

FIG. 7 is a block diagram showing configuration of the inserter control portion 601 for driving and controlling the inserter 600.

As shown in FIG. 7, the inserter control portion 601 has a CPU circuit portion 660 constituted by a CPU 661, a ROM 662 and a RAM 663. The CPU circuit portion 660 communicates and exchanges data with the CPU circuit portion 150 provided with the image forming apparatus 10 through a communication IC 664, and according to an instruction from the CPU circuit portion 150, executes various programs stored in the ROM 662 to drive and control the inserter 600. Further, the CPU circuit portion 660 receives input of detection signals from various path sensors S61, S62 and S63 as well as detection signals from the cover open/close detecting sensors S64, S65 and S66.

Drivers 665, 666 and 667 are connected to the CPU circuit portion 660.

The driver 665 drives a motor M61 of a horizontal conveyance processing module according to the signal sent from the CPU circuit portion 660.

The driver 666 drives a motor M62 of a vertical conveyance processing module according to the signal sent from the CPU circuit portion 660.

The driver 667 drives motors M63 and M64 of a sheet feeding processing module according to the signal sent from the CPU circuit portion 660.

Here, the horizontal conveyance processing module is constituted by the pairs of conveying rollers 602, 603 and 604 and the horizontal path conveying motor M61 as a driving source for these rollers.

The vertical conveyance processing module is constituted by the pairs of conveying rollers 641, 642 and 643 and the sheet feeding vertical path conveying motor M62 as a driving source for these rollers. The sheet feeding processing module is constituted by sheet feeding separating portions 636, 637 and 638, the sheet feeding separating portion motor M63 as a driving source for the sheet feeding separating portions and an intermediate plate elevating motor M64 as a driving source for elevation of intermediate plates 633, 634 and 635.

When it is detected that the cover 651 is in the opened state by the detection signal of the cover open/close detecting sensor S64, the power source of the driver 665 is shut off, thereby to forcefully stop driving of the horizontal conveyance processing module. At the same time, the power source of the driver 666 and the driver 667 is also shut off, thereby to forcefully stop all driving of the inserter 600.

On the other hand, when it is detected that the cover 652 is in the opened state by the detection signal of the cover open/close detecting sensor S65, the power source of the driver 666 is shut off, thereby to forcefully stop driving of the vertical conveyance processing module, and at the same time, the power source of the driver 667 is shut off, thereby to forcefully stop driving of the sheet feeding processing module.

On the other hand, when it is detected that the cover 653 is in the opened state by the detection signal of the cover open/close detecting sensor S66, the power source of the driver 667 is shut off, thereby to forcefully stop driving of the sheet feeding processing module.

[Configuration of Finisher Control Portion]

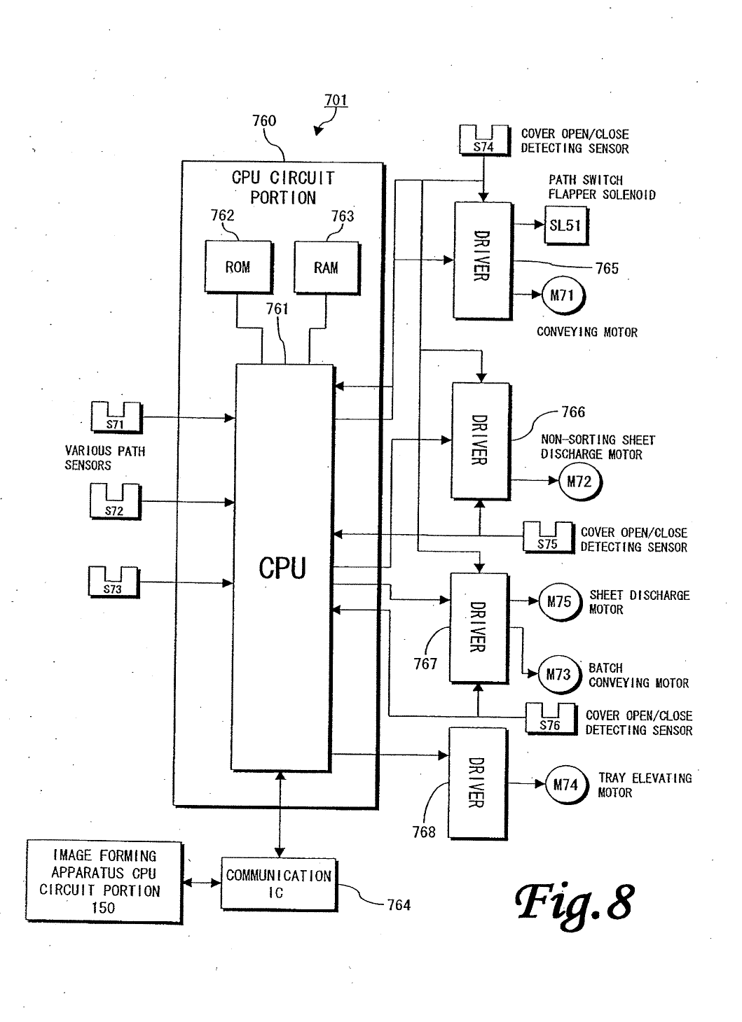

FIG. 8 is a block diagram showing configuration of the finisher control portion 701 for driving and controlling the finisher 700.

As shown in FIG. 8, the finisher control portion 701 has a CPU circuit portion 760 constituted by a CPU 761, a ROM 762 and a RAM 763. The CPU circuit portion 760 communicates and exchanges data with the CPU circuit portion 150 provided in the side of the image forming apparatus 10 through a communication IC 764, and according to an instruction from the CPU circuit portion 150, executes various programs stored in the ROM 762 to drive and control the finisher 700. Further, the CPU circuit portion 760 receives input of detection signals from path sensors S71, S72 and S73 as well as detection signals from the cover open/close detecting sensors S74, S75 and S76.

Drivers 765, 766, 767 and 768 are connected to the CPU circuit portion 760.

The driver 765 drives a motor M71 and a solenoid SL71 of a conveyance processing module according to the signal sent from the CPU circuit portion 760.

The driver 766 drives a motor M72 of a non-sorting sheet discharge processing module according to the signal sent from the CPU circuit portion 760.

The driver 767 drives motors M75 and M73 of a sorting sheet discharge processing module according to the signal sent from the CPU circuit portion 760.

The driver 768 drives a motor M74 of a loading processing module according to the signal sent from the CPU circuit portion 760.

Here, the conveyance processing module is constituted by the pair of inlet rollers 702, the conveying motor M71 as a driving source for the rollers and the solenoid SL71 for switching the path switch flapper 710.

The non-sorting discharge processing module is constituted by the pair of conveying rollers 706, the pair of non-sorting discharge rollers 703 and the sheet discharge motor M72 as a driving source for these rollers.

The sorting discharge processing module is constituted by the pair of sorting discharge rollers 704 and the sorting sheet discharge motor M75 as a driving source for the rollers, and the pair of discharge rollers 705 and the batch conveying motor M73 as a driving source for the rollers.

The sheet stacking processing module is constituted by the stack tray 722 and the tray elevating motor M74 as a driving source for the tray.

The conveying motor M71, the non-sorting sheet discharge motor M72 and the sorting sheet discharge motor M75 are formed of a stepping motor that can rotate the pair of rollers driven by each motor at a constant or particular velocity by controlling exciting pulse rate. The sheet bundle conveying motor M73 is formed of a DC motor.

When it is detected that the cover 751 is in the opened state by the detection signal of the cover open/close detecting sensor S74, the power source of the driver 765 is shut off, thereby to forcefully stop driving of the conveyance processing module. At the same time, the power source of the drivers 766, 767 and 768 is also shut off, thereby to forcefully stop all driving of the finisher 700.

On the other hand, when it is detected that the cover 752 is in the opened state by the detection signal of the cover open/close detecting sensor S75, the power source of the driver 766 is shut off, thereby to forcefully stop driving of only non-sorting processing module.

On the other hand, when it is detected that the cover 753 is in the opened state by the detection signal of the cover open/close detecting sensor S76, the power source of the driver 767 is shut off, thereby to forcefully stop driving of only sorting processing module.

[Description of Operation of Sheet Processing System]

Operation of the sheet processing system in accordance with this embodiment will be described below.

In the sheet processing system in accordance with this embodiment as a sheet output device, even if one preceding job as one work unit for sheet processing has not been finished, another job can be started so that plural jobs can be performed in parallel by arbitrarily combining the printer 300 as an image forming apparatus that forms an image on a sheet and outputs the sheet, the inserter 600 that outputs a sheet on which an image is not formed, the sheet stacking device 500 as a buffer device hat holds the output sheet temporarily and reoutputs the sheet and the finisher 700 as a sheet post-processing device.

Further, in addition to the printer 300 that forms an image on the sheet and outputs the sheet, the inserter 600 that outputs a sheet on which an image is not formed and the sheet stacking device 500 as a buffer device hat holds the output sheet temporarily and reoutputs the sheet, a sheet supplying device for supplying the sheet to the sheet processing apparatus may be provided as a sheet output device. Furthermore, a punching device for punching sheets, a binding device for binding sheets, a storing device for storing sheets, an aligning device for aligning sheets, a folding device for folding sheets and bookbinding device for binding sheets may be provided as a post-processing device.

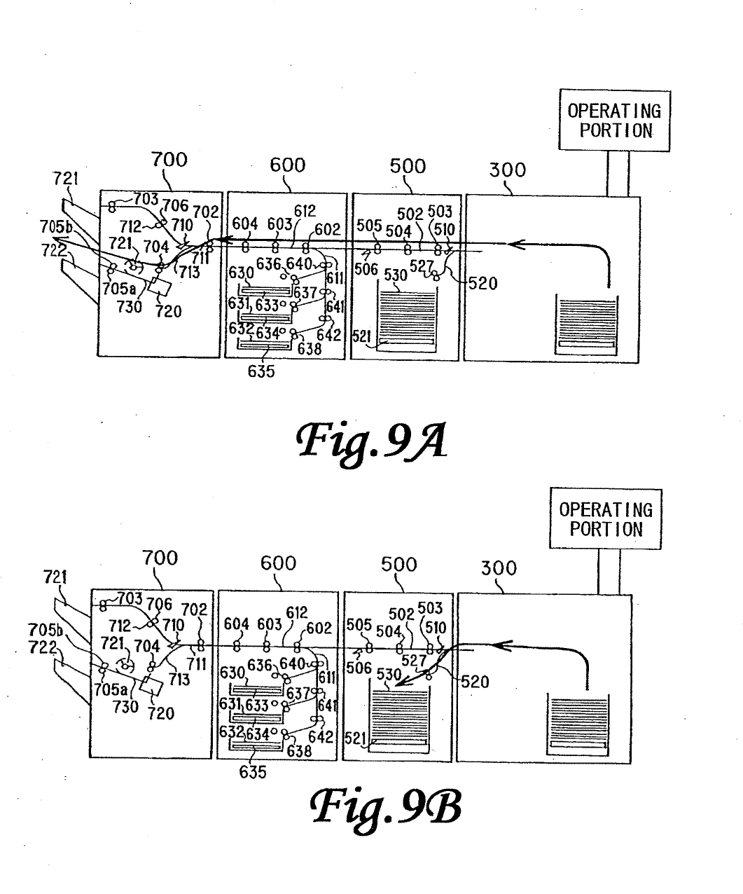

FIG. 9A is a view illustrating a first job. The first job is a bookbinding job in which a plurality of sheets on which an image is formed in the printer 300 are bundled for binding process in the finisher 700 and output therefrom in the combination of the printer 300, the sheet stacking device 500, the inserter 600 and the finisher 700.

When the first job is executed, in response to the instruction of the CPU 150 disposed at the image forming apparatus 10 to the CPU 561 disposed at the sheet stacking device 500, the first flapper 510 is switched so that the solenoid SL51 prevents the sheet from passing through the path 520 and the motor M51 of the conveyance processing module is activated to drive the pairs of conveying rollers 503, 504 and 505. Further, in response to the instruction of the CPU 150 disposed at the image forming apparatus 10 to the CPU 661 disposed at the inserter 600, the horizontal path conveying motor M61 of the horizontal conveyance processing module is activated to drive the pairs of conveying rollers 602, 603 and 604 on the conveying horizontal path 612.

And, in response to the instruction of the CPU 150 disposed at the image forming apparatus 10 to the CPU 761 disposed at the finisher 700, the switch flapper 710 is switched so that the solenoid SL71 prevents the sheet from passing through the non-sorting path 712 and the conveying motor M71, the sorting sheet discharge motor M75, the sheet bundle conveying motor M73 and tray elevating motor M74 of the conveyance processing module are activated to drive the pair of inlet rollers 702, the pair of sorting discharge rollers 704, the pair of discharge rollers 705 and the stack tray 722.

By controlling the sheet processing system A in this manner, the sheet on which an image is formed in the printer 300 is conveyed to and loaded on the intermediate tray 730 of the finisher 700 through the conveying horizontal path 502 of the sheet stacking device 500 and the conveying horizontal path 612 of the inserter 600.

The sheets loaded on the intermediate tray 730 in a batch are aligned and bound by the stapler 720 and then discharged on the stack tray 722. The stapler 720 can selectively perform process such as binding and punching as necessary.

FIG. 9B is a view illustrating a second job. The second job is a job of loading the sheet on which an image is formed in the printer 300 on the sheet stacking device 500 in the combination of the printer 300 and the sheet stacking device 500. By loading the sheet output from the printer 300 to the sheet stacking device 500 temporarily, it becomes possible to adjust and control processing capacity of the printer 300, the inserter 600 and the finisher 700.

When the second job is executed, in response to the instruction of the CPU 150 disposed at the image forming apparatus 10 to the CPU 561 disposed at the sheet stacking device 500, the first flapper 510 is switched so that the solenoid SL51 prevents the sheet from passing through the conveying horizontal path 502 and the motor M53 and the sheet stacking board motor M52 of the sheet stacking processing module are activated to drive the pair of conveying rollers 527 disposed along the conveying path 520 and the sheet stacking board 521 that constitutes the sheet stacking portion 530.

By controlling the sheet processing system A in this manner, the sheet on which an image is formed in the printer 300 is guided by the conveying path 520 so as to be loaded in the sheet stacking portion 530. At this time, the sheet stacking board 521 goes down depending on the amount of the loaded sheets.

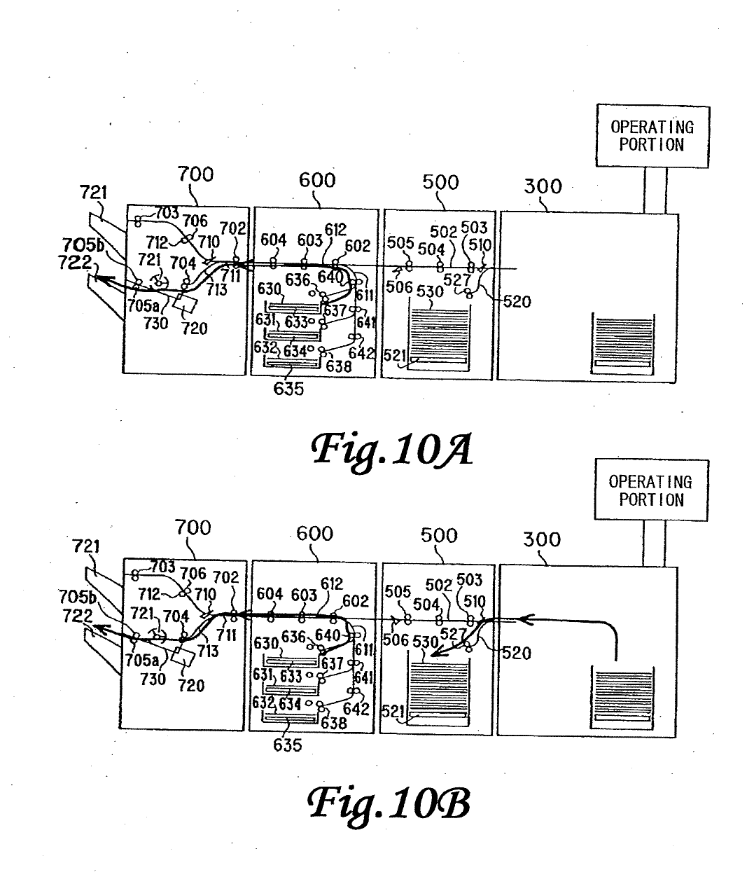

FIG. 10A is a view illustrating a third job. The third job is a bookbinding job in which a plurality of special sheets (such as color copy) stored in the inserter 600 are bundled for binding process in the finisher 700 and output in the combination of the inserter 600 and the finisher 700.

When the third job is executed, in response to the instruction of the CPU 150 disposed at the image forming apparatus 10 to the CPU 661 disposed at the inserter 600, the sheet feeding separating portion motor M63 an intermediate plate elevating motor M64 of the sheet feeding processing module are activated to drive the sheet feeding separating portions 636, 637 and 638 and the intermediate plates 633, 634 and 635.

Further, in response to the instruction of the CPU 150 disposed at the image forming apparatus 10 to the CPU 761 disposed at the finisher 700, the switch flapper 710 is switched so that the solenoid SL71 prevents the sheet from passing through the non-sorting path 712 and the conveying motor M71, the sorting sheet discharge motor M75, the batch conveying motor M73 and tray elevating motor M74 of the conveyance processing module are activated to drive the pair of inlet rollers 702, the pair of sorting discharge rollers 704, the pair of discharge rollers 705 and the stack tray 722.

By controlling the sheet processing system A in this manner, the special sheet such as color copy fed from the inserter 600 is conveyed to and loaded on the intermediate tray 730 of the finisher 700. Subsequently, the special sheets loaded on the intermediate tray 730 in a batch is aligned and bound by the stapler 720 and then discharged to the stack tray 722. The stapler 720 can selectively perform process such as binding and punching as necessary.

FIG. 10B is a view illustrating a fourth job. The fourth job is an operation of performing plural jobs in parallel in the sheet processing system of the present invention.

In the fourth job, while one job is executed in the combination of two or more sheet processing apparatuses that are adjacent to each other, another job is executed in the combination of two or more sheet processing apparatuses that are adjacent to each other except for the sheet processing apparatuses that executes the former job.

In other words, the job of loading the sheet on which an image is formed in the printer 300 in the sheet stacking device 500 as the second job is executed in parallel to the job of bundling a plurality of special sheets stored in the inserter 600 for binding process in the finisher 700 and outputting it as the third process.

In this manner, when the fourth job is executed, the third job is executed by combining two or more sheet processing apparatuses that are adjacent to each other except for the sheet processing apparatuses that execute the second job. Therefore, the conveying path 520 and the pair of conveying rollers 527 as a first sheet conveyance means used in executing the second job can be used separately from the conveying horizontal path 612, pairs of conveying rollers 602, 603 and 604, the finisher path 711, the sorting path 713, the pair of inlet rollers 702, the pair of sorting discharge rollers 704 and the pair of discharge rollers 705 as a second sheet conveyance means, which are used in executing the third job.

Therefore, even if the sheet processing apparatus used in executing one job does has not finished the job yet, as the sheet processing apparatus used in executing another job can be activated and execute another job before the termination of the preceding sheet processing, productivity of the sheet processing system can be improved.

When the fourth job is executed, in response to the instruction of the CPU 150 disposed at the image forming apparatus 10 to the CPU 561 disposed at the sheet stacking device 500, the second flapper 506 as blocking means is switched so that the solenoid SL52 prevents the sheet from passing to the side of the inserter 600.

For this reason, even if the sheet on which an image is formed in the image forming apparatus 10 is not loaded in the sheet stacking device 500 and conveyed onto the conveying horizontal path 502 due to failed operation of the first flapper 510 and the like, the second flapper 506 can prevent the sheet from flowing to the side of the inserter 600. Thus, it is possible to prevent mixture of sheets in plural jobs, thereby to improve the reliability of bookbinding.

Since other operations are same as the second job and the third job, description thereof is omitted.

Moreover, by combining the printer 300, the sheet stacking device 500 as a post-processing device, the inserter 600 and the finisher 700 arbitrarily, for example, printing job of forming an image in the printer 300 as one sheet processing apparatus may be executed in parallel with the third job executed in the combination of the inserter 600 and the finisher 700.

Alternatively, the first job and the third job may be executed in parallel. In this case, it is possible to execute two jobs in parallel by using the conveying horizontal path 612 and the pairs of conveying rollers 602, 603 and 604 that are disposed in the inserter 600 and all components in the finisher 700 in common.

Further, for example, the third job may interrupt and run during execution of the first job. Furthermore, when the first job and the third job are executed, the conveying horizontal path 612 and the pairs of conveying rollers 602, 603 and 604 as conveyance means of the inserter 600 may be used by turns.

Next, open and close operation of the covers of the sheet processing system A in accordance with the first embodiment will be described.

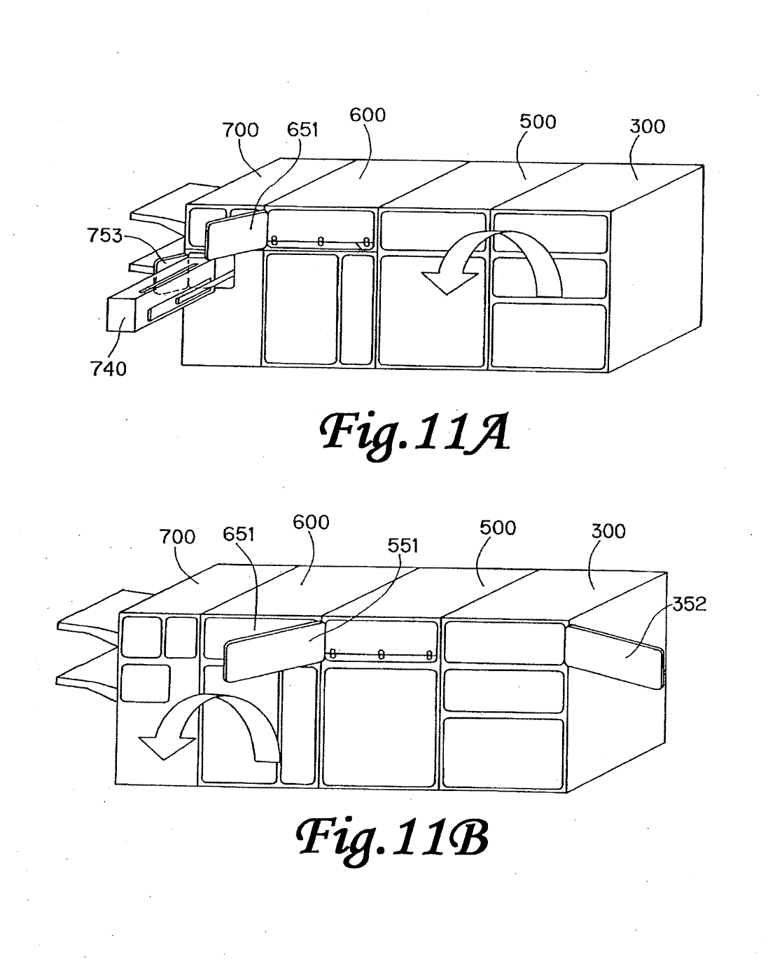

FIG. 11 is a view illustrating open-close operation of a cover of the sheet processing system A in accordance with the first embodiment.

As shown in FIG. 11A, covering members that allow the interior of each of the sheet processing apparatuses to become opened are each provided independently so that the sheet processing apparatus that executes one of the plural jobs executed in parallel and the sheet processing apparatus that executes another job can be maintenance separately from each other.

In other words, when the cover 651 set at the inserter 600 is opened, the conveying horizontal path 612 and the pairs of conveying rollers 602, 603 and 604 become accessible from outside of the device. When the cover 753 set at the finisher 700 is opened, the sorting processing portion 740 including the stapler 720 can be drawn out of the device.

Open or close operation of the cover 651 or the cover 753 is performed independently from control of the execution of the second job so that the second job of loading the sheet on which an image is formed in the printer 300 to the sheet stacking device 500 can be executed without any interruption even if the open or close operation of the cover 651 or the cover 753 is performed.

Although description is omitted, other covers set at the inserter 600 and the finisher 700 can be also opened or closed during execution of the second job without interrupting the job.

Further, as shown in FIG. 11B, when the cover 551 set at the sheet stacking device 500 is opened, the conveying horizontal path 502 and the pairs of conveying rollers 503, 504 and 505 become accessible from outside of the device. When the cover 352 set at the printer 300 is opened, the photosensitive drum 111 and the fixing portion 117 become accessible from outside of the device.

Open or close operation of the cover 551 or the cover 352 is performed independently from control of the execution of the third job so that the third job as a bookbinding job of bundling the plurality of special sheets (such as color copy) stored in the inserter 600 for binding process in the finisher 700 and outputting it can be executed without any interruption even if the open or close operation of the cover 651 or the cover 753 is performed.

Although description is omitted, other covers set at the printer 300 and the sheet stacking device 500 can be also opened or closed during execution of the third job without interrupting the job.

Therefore, in the sheet processing system A in accordance with this embodiment of the present invention in which two jobs are executed in parallel by combining two sheet processing apparatuses adjacent to each other, each of which executes one job, the cover and the operation control system set at one sheet processing apparatus that executes one job are provided independently for each conveying path so as not to interrupt parallel processing with another sheet processing apparatus executing another job. As a result, in parallel processing of plural jobs, even if the sheet processing apparatus that executes any one of jobs is stopped, remaining job can be executed without being interrupted.

That is, when the cover 651 of the inserter 600 is opened during execution of the fourth job, the cover open/close detecting sensor S64 detects the open state of the cover 651 and the power source of the driver 565 is shut off. As a result, the power source of the horizontal path conveying motor M61 as a driving source for the pairs of conveying rollers 602, 603 and 604, the sheet feeding vertical path conveying motor M62 as a driving source for the pairs of conveying rollers 641, 642 and 643 and the sheet feeding separating portion motor M63 as a driving source for the sheet feeding separating portions 636, 637 and 638 is shut off and at the same time, all power source of the drivers 765, 766, 767 and 768 disposed at the finisher 700 that is operating in combination with the inserter 600 is also shut off. Consequently, all the driving of the finisher 700 is forcefully stopped, thereby to terminate the third job.

However, the printer 300 and the sheet stacking device 500 are controlled independently from the inserter 600 and the finisher 700 so that the second job can be executed.

Even if other covers 652, 751 and 753 set at the inserter 600 and the finisher 700 are opened, the second job can be executed.

On the other hand, the cover of the printer 300 or the sheet stacking device 500 is opened during execution of the fourth job, operation of the printer 300 and the sheet stacking device 500 is forcefully stopped, thereby to terminate the second job, but the inserter 600 and the finisher 700 are controlled independently from the printer 300 and the sheet stacking device 500 so that the third job can be executed without any interruption.

For this reason, when executing plural jobs in parallel, the cover of the sheet processing apparatus executing any one of the jobs is opened because of jam repair, replacement of parts, cleaning and supply of sheets and so on, and driving of only the sheet processing apparatus requiring such maintenance is stopped, while the other job is executed continuously.

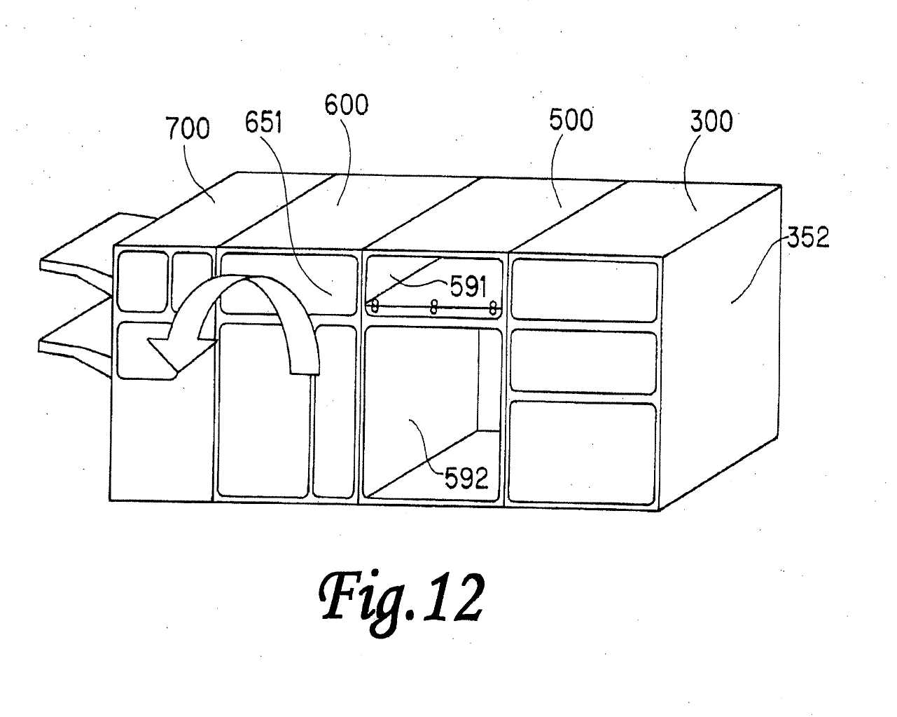

FIG. 12 is a view illustrating configuration of partitions.

As shown in FIG. 12, the sheet processing system A in accordance with this embodiment has partitions 591 and 592 for separating the sheet stacking device 500 from the inserter 600. In FIG. 11, the covers 551 and 552 of the sheet stacking device 500 and its internal configuration are omitted for convenience of explanation of the partitions 591 and 592.

The partitions 591 and 592 prevent the access from the sheet stacking device 500 to the inserter 600 and vice versa. By using the partitions 591 and 592, for example, it can be prevented that the sheet stacking device 500 in which the second job is stopped has access to the inserter 600 in which the third job is under execution, thereby to interrupt the execution of the third job (for example, the sheet during conveying or path sensor is touched). On the other hand, it can be also prevented that the inserter 600 in which the third job is under execution has access to the sheet stacking device 500 in which the second job is under execution.

As described above, in the sheet processing system A in accordance with this embodiment, a driving source that constitutes each conveyance processing module is provided for each path, but the present invention is not limited to the configuration. For example, the pairs of discharge rollers 118 of the printer 300 and the conveying horizontal path 502 of the sheet stacking device 500 may be driven by the same driving source. Alternatively, the conveying horizontal path 612 of the inserter 600 and the pairs of inlet rollers 702 of the finisher 700 may be driven by the same driving source. Similarly, as to the cover set at each of the sheet processing apparatuses, the cover 352 of the printer 300 and the cover 551 of the sheet stacking device 500 may be formed of the same single cover. Alternatively, the cover 651 of the inserter 600 and the cover 751 of finisher 700 may be formed of the same single cover.

### Second Embodiment

Next, a second embodiment of the present invention will be described.

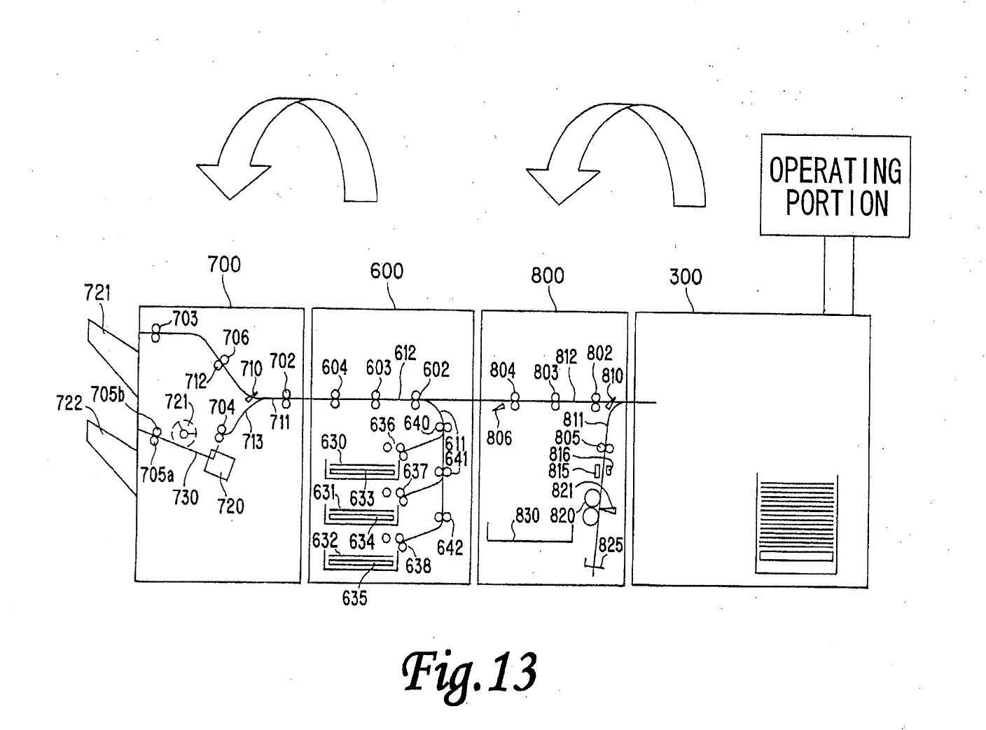

FIG. 13 is a schematic configuration view showing internal configuration of a sheet processing system in accordance with the second embodiment of the present invention.

The sheet processing system in accordance with this embodiment is configured by serially connecting the printer 300, a bookbinding device 800, the inserter 600 and the finisher 700, each of which is a sheet processing apparatus with a sheet processing function of its own, in this order.

[Bookbinding Device 800]

The bookbinding device 800 has a bookbinding conveying horizontal path 812 for guiding the sheet discharged from the printer 300 into the side of the inserter 600, pairs of conveying rollers 802, 803 and 804 disposed along the bookbinding horizontal path 812, a bookbinding path 811 that diverges from the bookbinding horizontal path 812 downwards, a pair of conveying rollers 805 disposed along the bookbinding path 811, a bookbinding path selecting flapper 810 that is disposed at an inlet of the bookbinding conveying horizontal path 812 and performs switching operation for selectively guiding the sheet into the side of the bookbinding path 811 or the inserter 600, a flapper 806 disposed at an exit of the bookbinding horizontal path 812, two pairs of staplers 815 disposed in the midpoint of the bookbinding path 811 and anvils 816 disposed so as to be opposed to the staplers 815, a pair of folding rollers 820 disposed below the staplers 815, a thrust member 821 disposed so as to be opposed to the folding rollers 820, a movable sheet positioning member 825 that is disposed below the folding rollers 820 and performs positioning the front end of the sheet guided by the bookbinding path 811 and a bookbinding discharge tray 830.

When the bookbinding device 800 executes a bookbinding job, the sheet printed by the printer 300 is conveyed to the place where its front end comes contact with the movable positioning member 825 under the guide of the bookbinding path 811 and stored temporarily. Then, by thrusting the thrust member 821 toward a batch of sheets stored in the bookbinding path 811, the batch of sheets is folded and discharged from between the pair of rollers 820 onto the bookbinding discharge tray 830. When the batch of sheets bound by the stapler 815 is folded, the positioning member 825 is lowered as necessary so that the stapled position of the batch of sheets is located at the center of the pair of folding rollers 820 after stapling process.

On the other hand, when the above-mentioned bookbinding job is not executed, the bookbinding path selecting flapper 810 is switched so as to prevent the sheet from passing to the bookbinding path 811 and the sheet is conveyed to the side of the inserter 600 through the bookbinding horizontal path 812.

Also in the sheet processing system having such bookbinding device 800, two jobs can be executed in parallel by using the printer 300 and the bookbinding device 800, and the inserter 600 and the finisher 700.

Since other configuration of the sheet processing system of this embodiment is the same as that of the sheet processing system A of the first embodiment, description thereof is omitted.

### Third Embodiment

Next, a third embodiment of the present invention will be described.

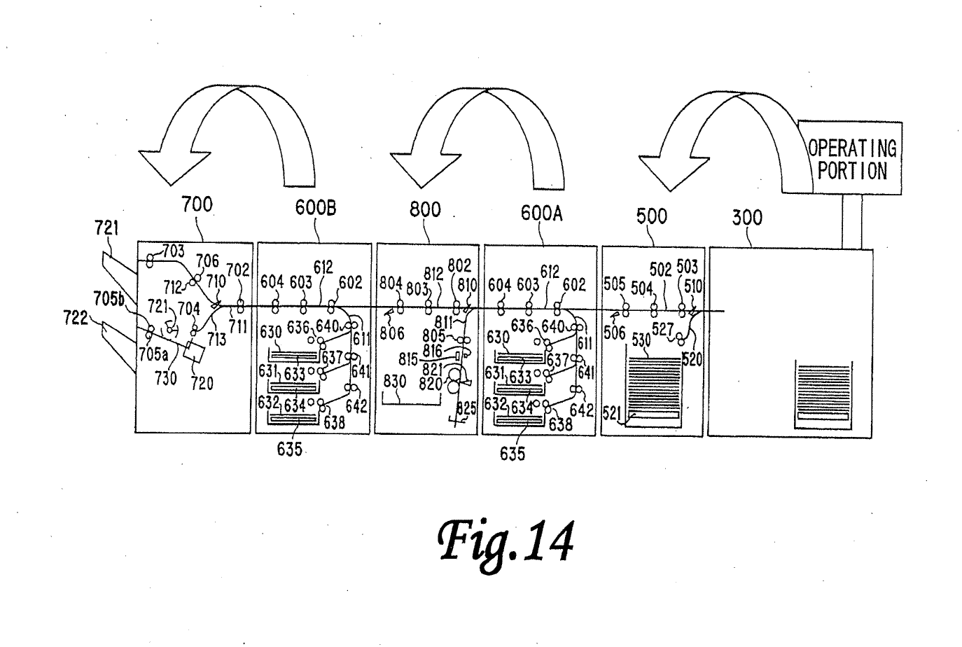

FIG. 14 is a schematic configuration view showing internal configuration of the sheet processing system in accordance with the third embodiment of the present invention.

The sheet processing system in accordance with the third embodiment is configured by serially connecting the printer 300, the sheet stacking device 500, a set of inserters 600A and 600B, the bookbinding device 800 and the finisher 700, each of which has a sheet processing function of its own, as shown in FIG. 14.

In such sheet processing system, three jobs can be executed in the combination of the printer 300 and the sheet stacking device 500, the inserter 600A and the bookbinding device 800, and the inserter 600B and the finisher 700.

In this manner, one job is executed by combining two sheet processing apparatuses adjacent to each other, while another job is executed by combining two sheet processing apparatuses that are adjacent to each other except for the sheet processing apparatuses that execute the former job.

Therefore, even if the sheet processing apparatus used in executing one job has not finished the job yet, as the sheet processing apparatus used in executing another job can be activated and productivity of the sheet processing system can be improved.

Any combination of the sheet processing apparatuses is acceptable. For example, one job can be executed in the combination of the printer 300, the inserter 600A and the finisher 700 in parallel with the other job.

Since other configuration of the sheet processing system of this embodiment is the same as that of the sheet processing system A of the first embodiment, description thereof is omitted.

### Fourth Embodiment

Next, a fourth embodiment of the present invention will be described.

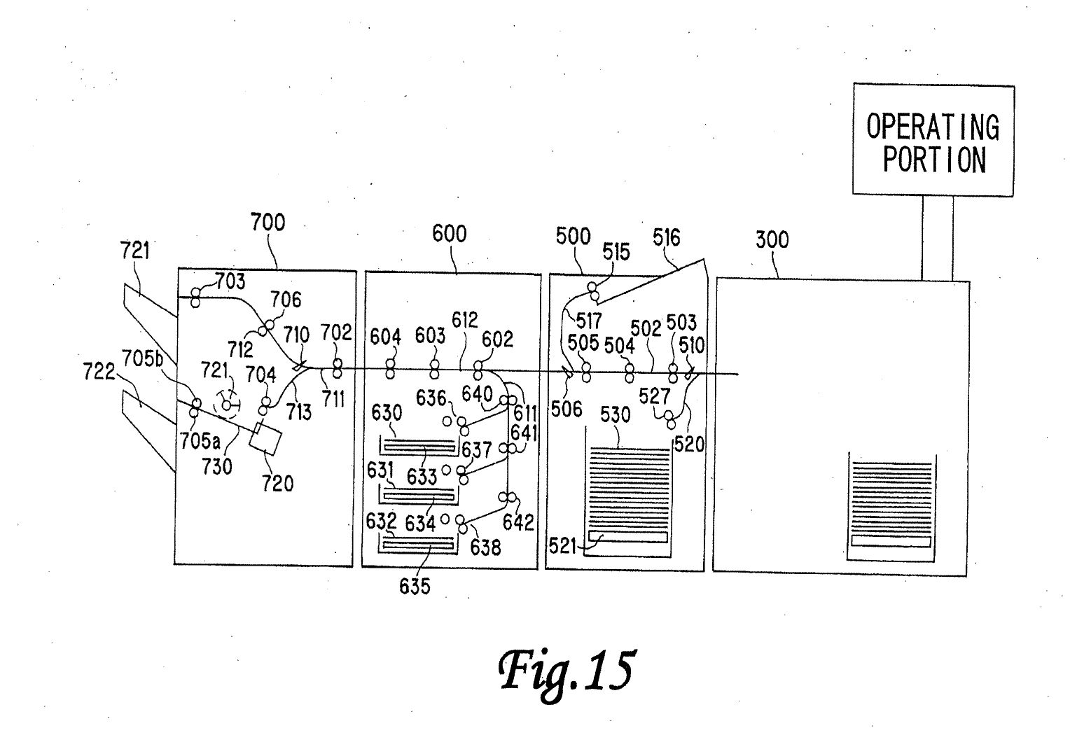

FIG. 15 is a schematic configuration view showing internal configuration of a sheet processing system in accordance with the fourth embodiment of the present invention.

The sheet processing system in accordance with this embodiment is configured so that a sheet stacking device 500 with a retreat tray is connected between the printer 300 and the inserter 600.

The sheet stacking device 500 has the sheet stacking portion 530 for loading the sheet printed by the printer 300 temporarily, the conveying horizontal path 502, a retreat path 517 that diverges from the conveying horizontal path 502 at the side of the inserter 600, a pair of retreat path rollers 515 disposed on the retreat path 517, a retreat tray 516 mounted on the upper face of the sheet stacking device 500, the first flapper 510 disposed at the inlet of the conveying horizontal path 502 and the second flapper 506 for guiding the sheet to the retreat path 517.

In such sheet processing system, when the job of loading the sheet on the sheet stacking device 500 after image formation in the printer 300 and the job of performing bookbinding such as stapling process in the finisher 700 after supply of the special sheet from the inserter 600 are executed in parallel, even if the sheet to be conveyed to the sheet stacking portion 530 is guided to the conveying horizontal path 502 due to failed operation of the first flapper 510, the sheet can be guided from the retreat path 517 to the retreat tray 516.

For this reason, the sheet conveyed from the printer 300 to the sheet stacking device 500 is discharged on the retreat tray 516 without being included in the job in the finisher 700 nor jammed within the sheet stacking device 500.

Therefore, by preventing mixture the sheets in different jobs, reliability of bookbinding operation can be improved. Moreover, operating efficiency of the sheet stacking device 500 can be also improved.

Since other configuration of the sheet processing system of this embodiment is the same as that of the sheet processing system A of the first embodiment, description thereof is omitted.

The above-mentioned embodiments will be summarized as follows.

(1) The sheet processing system in accordance with the embodiments has a plurality of sheet processing apparatuses having sheet processing function (the printer 300, the sheet stacking device 500, the inserter 600, the finisher 700 and the bookbinding device 800) and executes plural jobs by using the plurality of sheet processing apparatuses.

For this reason, even if the sheet processing apparatus used in executing one job has not finished the job yet, the sheet processing apparatus used in executing another job can be activated and execute another job in parallel before the termination of the preceding sheet processing.

(2) The sheet processing system in accordance with the embodiments executes one of the plural jobs by combining the sheet processing apparatuses adjacent to each other.

(3) The sheet processing system in accordance with the embodiments executes one of the plural jobs by combining two sheet processing apparatuses adjacent to each other, as well as another job by combining two sheet processing apparatuses that are adjacent to each other except for the sheet processing apparatuses that execute the former job.

Accordingly, even if the sheet processing apparatus used in executing one job is stopped, as the sheet processing apparatus used in executing the other job can be activated and executes the job, productivity of the sheet processing system can be improved.

(4) The plurality of sheet processing apparatuses are sheet output devices for outputting the sheet (the printer 300, the sheet stacking device 500, the inserter 600) or post-processing devices for applying post-processing to the sheet output from the sheet output device (the finisher 700, the bookbinding device 800).

(5) The sheet output device is the printer 300 for forming an image on a sheet and outputting the sheet, the inserter 600 for outputting a sheet on which an image is not formed, the buffer device 500 for holding the sheet output from other sheet output device temporarily and reoutputting the sheet, or the sheet feeding devices 114 and 115 for feeding the sheet to other sheet processing apparatus.

(6) The post-processing device is the punching device 700 for punching the sheet, the binding device 700 for binding sheets, the storing device for storing sheets therein, the aligning device 700 for aligning sheets, the folding device for folding the sheets or the bookbinding device for binding sheets.

(7) The plurality of sheet processing apparatuses (the printer 300, the sheet stacking device 500, the inserter 600) are arranged in series and sheet conveyance means conveying the sheets in the sheet processing apparatuses adjacent to each other is provided, and the sheet conveyance means is connected in series from the most upstream sheet processing apparatus to the most downstream sheet processing apparatus in the direction of outputting the sheet.

(8) The sheet conveyance means has a first sheet conveyance means used in executing one of the plural jobs executed in parallel (the conveying path 520 and the pair of the conveying rollers 527) and a second sheet conveyance means used in executing the other job (the conveying horizontal path 612, the pairs of conveying rollers 602, 603 and 604, the finisher path 711, the sorting path 713, the pair of inlet rollers 702, the pair of sorting discharge rollers 704 and the pair of discharge rollers 705).

(9) The blocking means 506 for blocking passage of the sheet is provided between the first sheet conveyance means and the second sheet conveyance means.

(10) The partitions 591 and 592 for separating the sheet processing apparatus that executes one of the plural jobs executed in parallel from the sheet processing apparatus that executes the other job are provided.

(11) The cover members that allow the interior of the sheet processing apparatuses to become opened are provided so that the sheet processing apparatus that executes one of the plural jobs executed in parallel and the sheet processing apparatus that executes the other job can be maintained separately.

Accordingly, when executing plural jobs in parallel, the cover of the sheet processing apparatus executing any one of the jobs is opened because of jam repair, replacement of parts, cleaning and supply of sheets and so on, and driving of only the sheet processing apparatus requiring such maintenance is stopped, while the other job is executed continuously.

This application claims priority from Japanese Patent Application No. 2003-356736 filed Oct. 16, 2003, which is hereby incorporated by reference, herein.

What is claimed is:

1. A sheet processing system comprising:
a plurality of sheet output devices which output a sheet;
a plurality of sheet post-processing devices which apply post-processing to the sheet output from the sheet output device; and
a controller which controls the sheet output devices and the sheet post-processing devices,
wherein the controller executes a job of sheet processing using a combination of the sheet output device and the sheet post-processing device, the controller being capable of executing plural jobs in parallel by plural combinations of the devices,
wherein, when plural combinations are selected in order to execute plural jobs in parallel, the sheet output device which outputs a sheet to execute one of the plural jobs differs from the sheet output device which outputs a sheet to execute another job.

2. A sheet processing system according to claim 1, wherein
the controller is configured to execute one of the plural jobs in a combination of the sheet output device and the sheet post-processing device, adjacent to each other.

3. A sheet processing system according to claim 1, wherein
the controller is configured to execute one of the plural jobs in a combination of the sheet output device and the sheet post-processing device, adjacent to each other, and another job in parallel in a combination adjacent to each other except for the former combination.

4. A sheet processing system according to claim 1, wherein
the controller is configured to execute plural jobs in parallel by using at least one common downstream sheet post-processing device which is common to the plural jobs and which is downstream of another sheet post-processing device in the selected combinations in the conveying direction of the sheet.

5. A sheet processing system according to claim 1, wherein
the controller is configured to make another job interrupt its tasks during execution of one of the plural jobs.

6. A sheet processing system according to claim 1, further comprising a sheet conveying path which conveys the sheet between the plurality of the sheet output devices and the plurality of the sheet post-processing devices which are arranged in series adjacent to each other,
wherein the sheet conveying path conveys the sheet from the most upstream sheet output device to the most downstream sheet post-processing device in the conveying direction of the sheet.

7. A sheet processing system according to claim 6, wherein
the sheet conveying path comprises:
a first sheet conveying path used in executing one of the plural jobs, and
a second sheet conveying path used in executing another job.

8. A sheet processing system according to claim 7, wherein
the first sheet conveying path and the second sheet conveying path are joined with each other and wherein said system further comprises a flapper which blocks passage of the sheet and is provided at a joining portion of the first sheet conveying path and t he second sheet conveying path.

9. A sheet processing system according to claim 1 further comprising:
a partition which separates a combination of the devices which executes one of the plural jobs from a combination of the devices which execute another job.

10. A sheet processing system according to claim 1, further comprising:
a cover member provided on the sheet output devices and the sheet post-processing devices, which allows the interior of each device to become opened; and
a sensor provided on each device, which detects an close/open state of the cover member,
wherein the controller performs suspension control of one of a sheet output device and a sheet post-processing device, or a combination thereof which execute one of the plural jobs executed in parallel, and one of a sheet output device and a sheet post-processing device or a combination thereof which executes another job, respectively, based on a signal from each sensor.

11. A sheet processing system according to claim 1, wherein
one of the sheet output devices is one of
an image forming apparatus which forms an image on a sheet and outputs the sheet,
an inserter which does not form an image on a sheet and outputs the sheet,
a buffer device which temporarily holds the sheet output from another sheet output device and re-outputs the sheet, and
a sheet feeding device configured and positioned to feed feeding the sheet to another sheet output device or a sheet post-processing device.

12. A sheet processing system according to claim 1, wherein
one of the sheet post-processing devices is one of
a punching device configured and positioned to punch sheets,
a binding device configured and positioned to bind sheets,
a storing device configured and positioned to store sheets,
an aligning device configured and positioned to align sheets,
a folding device configured and positioned to fold sheets, and
a bookbinding device configured and positioned to bind sheets.
